(19) United States
(12) Patent Application Publication
(10) Pub. No.: US 2004/0054673 A1
(43) Pub. Date: Mar. 18, 2004

(54) Provision of search topic-specific search results information

(76) Inventors: William Sanford deMent, Eagle, ID (US); DeAnna Johnson, Eagle, ID (US); Kari Compton Rishel, Star, ID (US)

Correspondence Address: HEWLETT-PACKARD COMPANY, Intellectual Property Administration, P.O. Box 272400, Fort Collins, CO, 80527-2400, US

(21) Appl. No.: 10/241,888

(22) Filed: Sep. 12, 2002

(51) Int. Cl. G06F 17/30; G06F 7/00

(52) U.S. Cl. 707/5

(57) ABSTRACT

The present disclosure relates to information searching. Systems and methods for facilitating such information search are described. In one arrangement, a system and method for facilitating information searching pertain to receiving search content, locating a document that is potentially relevant to the search content, and providing search results that identify the located document, the search results including a search topic-specific title that is other than an actual title of the document.

### FIELD OF THE INVENTION

The present disclosure relates to information searching. More particularly, the disclosure relates to the provision of search result information that is descriptive of the particular information that the searcher is seeking.

### BACKGROUND OF THE INVENTION

Customers often access electronic data sources to obtain information about the products they own or are considering purchasing. One common source of such information is web sites supported by or on behalf of product manufacturers.

In that web sites typically include, or provide links to, a large amount of information, various devices are normally provided with which the customer can more easily locate desired information. One such device is the search engine. As is known in the art, search engines permit customers and other users to enter search queries comprising one or more words, terms, or phrases that pertain to the information that is sought. Often, the words/terms/phrases used in the search queries are used to locate documents that contain these words/terms/phrases and, therefore, potentially contain the information for which the customer is searching. In such a case, the located documents are normally presented to the user in a listing that includes the titles of the documents and, occasionally, a brief excerpt of the documents.

Although search engines such as those described above can narrow the focus of the customer's search, it can be difficult for customers to determine which documents contain the desired information from the listing provided in the search results. More specifically, the document titles identified in the results listings often are too generic to convey whether or not the document includes the specific information that the customer desires. This is particularly the case where the documents are long and contain many different types of information. Even though document excerpts are sometimes also provided in the search results, these excerpts usually are too cryptic to identify the documents as containing or not containing the desired information.

Because of the lack of indication as to the presence or absence of the sought information, the customer typically must waste time parsing through one or several of the located documents to determine which, if any, contain the information that the customer seeks. This process can be very frustrating for the customer, particularly if the customer does not ultimately locate the desired information.

From the above, it can be appreciated that it would be desirable to provide search results that more clearly identify to the customer or other user which documents, if any, contain the information that the user is seeking.

### SUMMARY OF THE INVENTION

The present disclosure relates to information searching. Systems and methods for facilitating such information searching are described. In one arrangement, a system and method for facilitating information searching pertain to receiving search content, locating a document that is potentially relevant to the search content, and providing search results that identify the located document, the search results including a search topic-specific title that is other than an actual title of the document.

By way of example, the search topic-specific data can comprise a search topic-specific title, other than an actual title of the document, that has been generated by heuristic evaluation. In addition, a product number can, optionally, be provided in the search results.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a block diagram of an example system that facilitates the provision of search topic-specific data in search results.

FIG. 2 is a schematic view of an example network-based system for providing search topic-specific data in search results.

FIG. 3 is a block diagram of a data source computing device shown in FIG. 2.

FIG. 4 is a flow diagram of an example method for providing search topic-specific data in search results.

FIGS. 5A and 5B are a flow diagram of an example of operation of a search engine shown in FIG. 3 in providing search topic-specific data in search results.

FIG. 6 is an example look-up table in which various information is associated.

### DETAILED DESCRIPTION

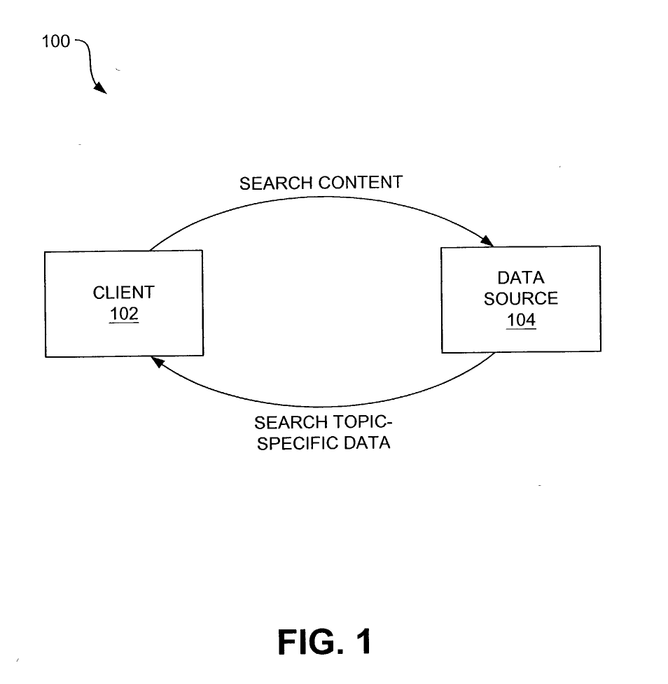

Referring now in more detail to the drawings, in which like numerals indicate corresponding parts throughout the several views, FIG. 1 illustrates a generalized system 100 for facilitating the provision of search topic-specific data in search results. As used in the context of this document, the term “search topic-specific data” is an inclusive term that denotes data that are relevant in some manner to the search topic or topics identified during an information search. These topics can be explicitly or implicitly identified in the search (e.g., through a search query) and, therefore, by the words, terms, and/or phrases used in the search.

As indicated in FIG. 1, the system 100 comprises a client 102 and a data source 104. The client 102 typically comprises a user and/or a user device such as a computing device, and the data source 104 typically comprises a computing device and/or service. As illustrated in FIG. 1, search content is transferred from the client 102 to the data source 104 and, in return, search topic-specific data is transferred from the data source back to the client. As described in greater detail below, one or more search queries or other search content can be transmitted to the data source 104 from the client 102 so as to receive search results that include data that are specific to the search content.

With the exchange of information summarized above, a user can obtain more meaningful search results that convey with greater clarity which search results (e.g., documents) contain the information that the user is seeking. The manners in which such search results are obtained are described in greater detail in the discussions that follow.

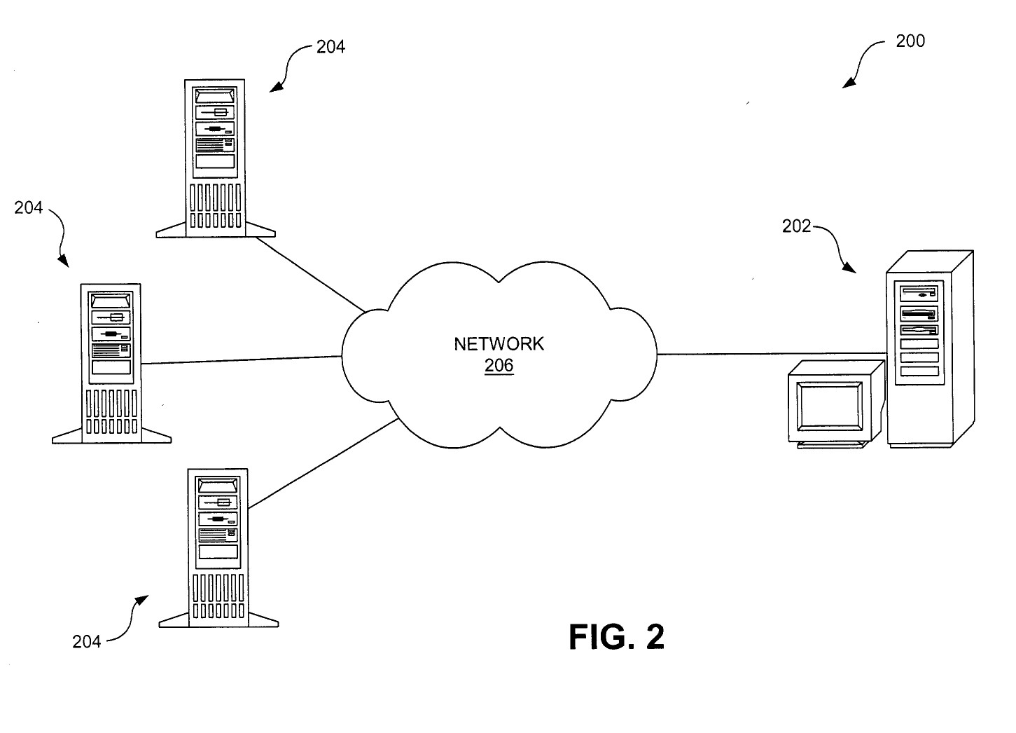

FIG. 2 illustrates an example network-based system 200 that facilitates the provision of search topic-specific data to a user conducting an information search. As indicated in the figure, the system 200 comprises a user computing device 202 and one or more data source computing devices 204. The computing devices 202, 204 comprise substantially any computing device that is configured to process and/or store data. By way of example, the user computing device 202 comprises a desktop personal computer (PC), notebook PC, personal digital assistant (PDA), mobile telephone, or the like. Notably, although the term “user computing device” is used, the device 202 need not be owned or possessed by the user. Therefore, the user computing device 202 could, optionally, comprise a computing device made generally available to the public in, for instance, a kiosk or other public location.

The data source computing devices 204 normally comprise a mainframe computer, server computer, PC, or other such computing device typically used to serve information to one or more users over a network. Accordingly, the computing devices 204 may have configurations similar to the user computing device 202, but often have greater computing and/or storage capacities.

As indicated in FIG. 2, each of the computing devices 202, 204 is connected to a network 206. These connections can comprise direct, i.e., wired, connections or wireless connections. In the former case, connectivity may be facilitated through a hardwired network using a protocol such as Ethernet, or through a shared system such as a telephone and/or powerline network. In the wireless context, connectivity may be facilitated with a wireless networking protocol such as Bluetooth™ from Bluetooth SIG™ or 802.11 protocol from the Institute of Electrical and Electronics Engineers (IEEE).

As will be appreciated from the discussion that follows, the precise configuration and protocol used to form the network 206 are not critical. Typically, however, the network 206 comprises one or more sub-networks that are communicatively coupled to each other. By way of example, these networks include one or more local area networks (LANs) and/or wide area networks (WANs). Indeed, in some embodiments, the network 206 may comprise a set of networks that forms part of the Internet.

Although the user computing device 202 and the data source computing devices 204 are illustrated as only being connected to each other via the network 206, it is to be appreciated that, alternatively or in addition, the user computing device and the data source computing devices could be directly connected to each other so as to obviate the need for a network connection.

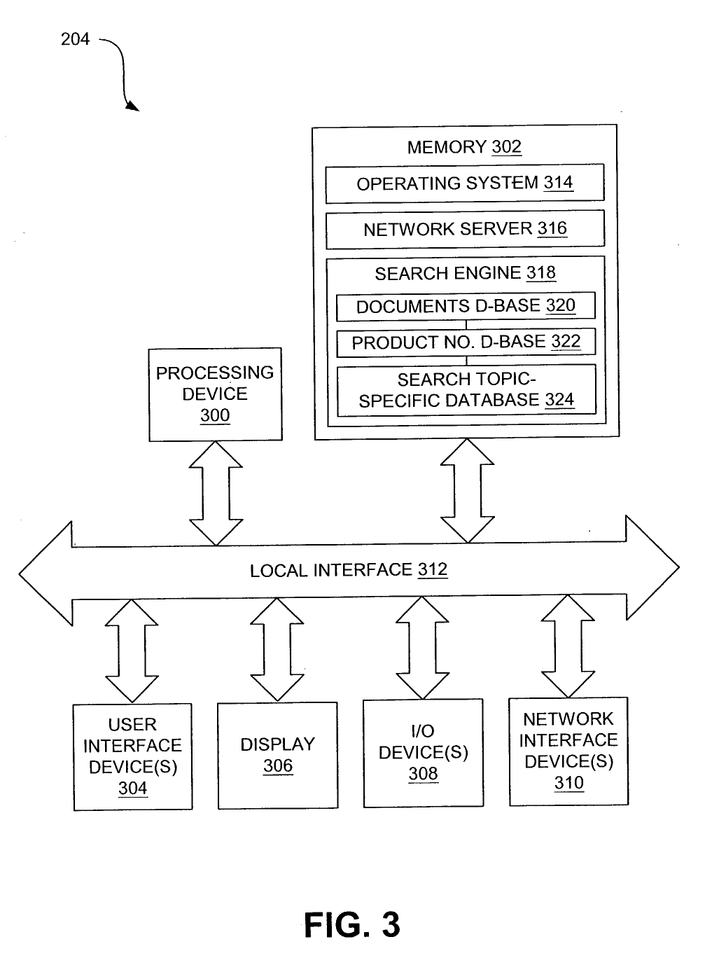

FIG. 3 is a block diagram of an example architecture for any one of the data source computing devices 204 shown in FIG. 2. As indicated in FIG. 3, each computing device 204 can, for instance, comprise a processing device 300, memory 302, one or more user interface devices 304, a display 306, one or more input/output (I/O) devices 308, and one or more network interface devices 310, each of which is connected to a local interface 312 that can comprise one or more internal and/or external buses. The processing device 300 can include any custom made or commercially available processor, a central processing unit (CPU) or an auxiliary processor among several processors associated with the computing device, a semiconductor based microprocessor (in the form of a microchip), or a macroprocessor. The memory 302 can include any one of a combination of volatile memory elements (e.g., RAM, such as DRAM, SRAM, etc.) and nonvolatile memory elements (e.g., ROM, hard disk, tape, CDROM, etc.).

The one or more user interface devices 304 comprise those components with which a user (e.g., administrator) can interact with the computing device 204. By way of example, these components can comprise those normally used with a PC such as a keyboard and mouse. Similarly, the display 306 can comprise a component normally used with a PC, for instance, a computer monitor.

The one or more I/O devices 308 comprise components used to facilitate connection of the computing device 204 to other systems or devices. These I/O devices 308 can, for instance, comprise one or more serial, parallel, small system interface (SCSI), universal serial bus (USB), IEEE 1394 (e.g., Firewire™), or personal area network (PAN) connection devices.

The network interface devices 310 comprise the various components used to transmit and/or receive data over a network (e.g., network 206). By way of example, the network interface devices 310 include a device that can communicate both inputs and outputs, for instance, a network card, modulator/demodulator (e.g., modem), wireless (e.g., radio frequency (RF)) transceiver, a telephonic interface, a bridge, a router, etc.

With further reference to FIG. 3, the memory 302 can comprise an operating system 314, a network server 316, and a search engine 318. The operating system 314 comprises the software and/or firmware that controls the general operation of the computing device 204. The network server 316, where provided, comprises the software and/or firmware that is used to present, i.e. serve, data to users. By way of example, these data can be served to the user via a user browser that is installed on the user computing device 202.

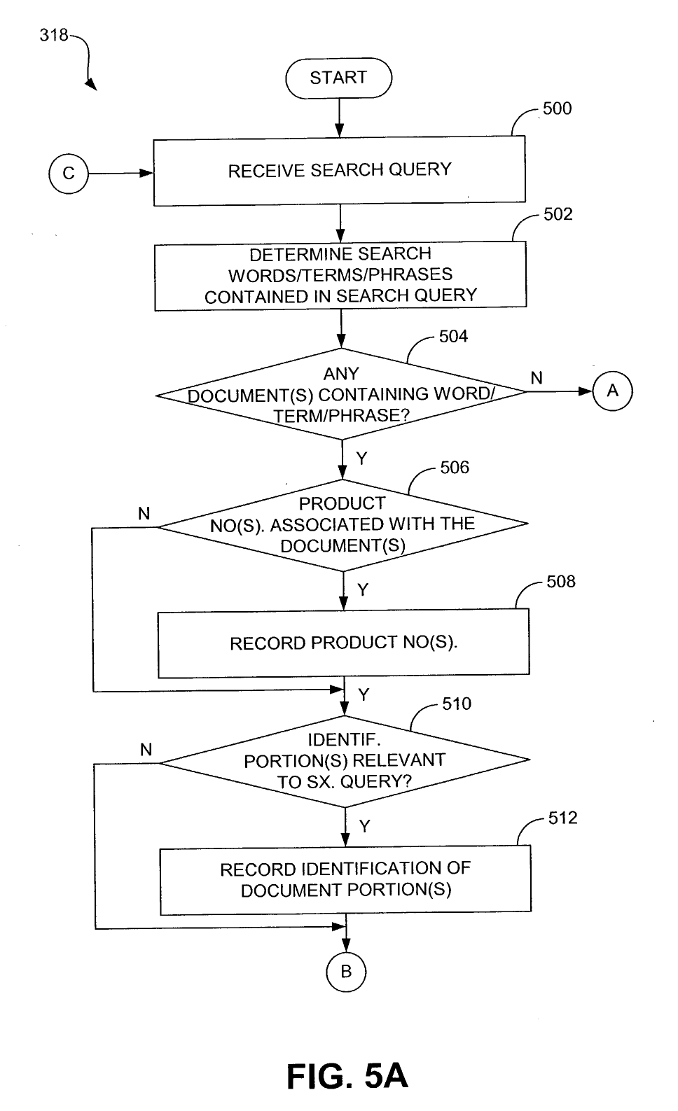

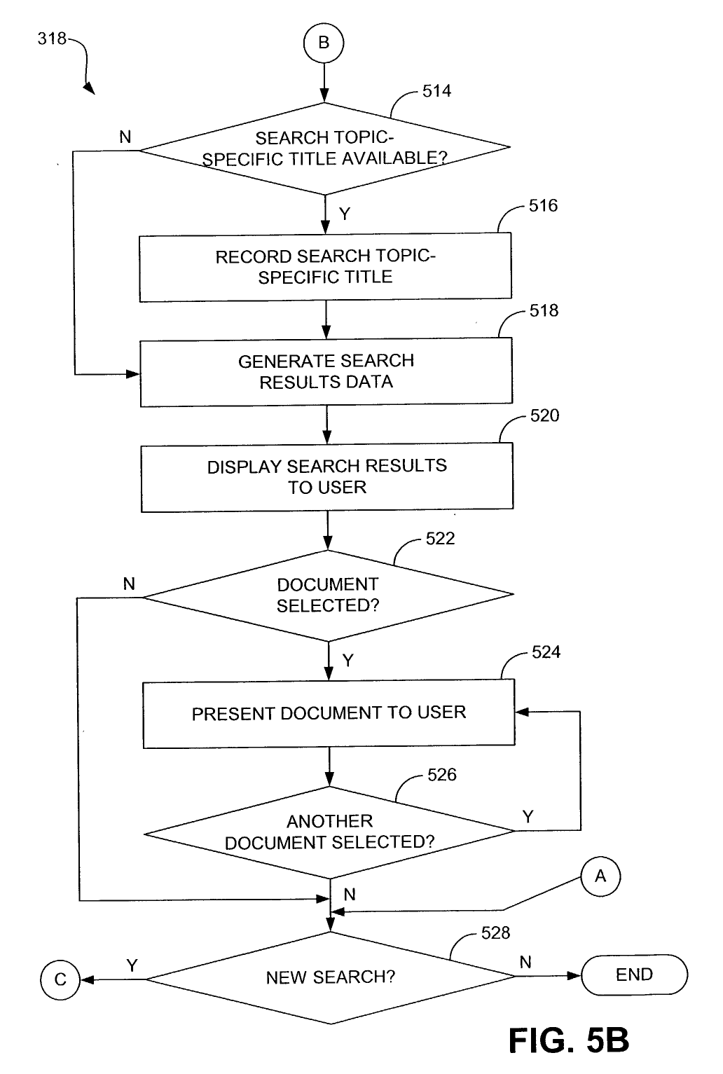

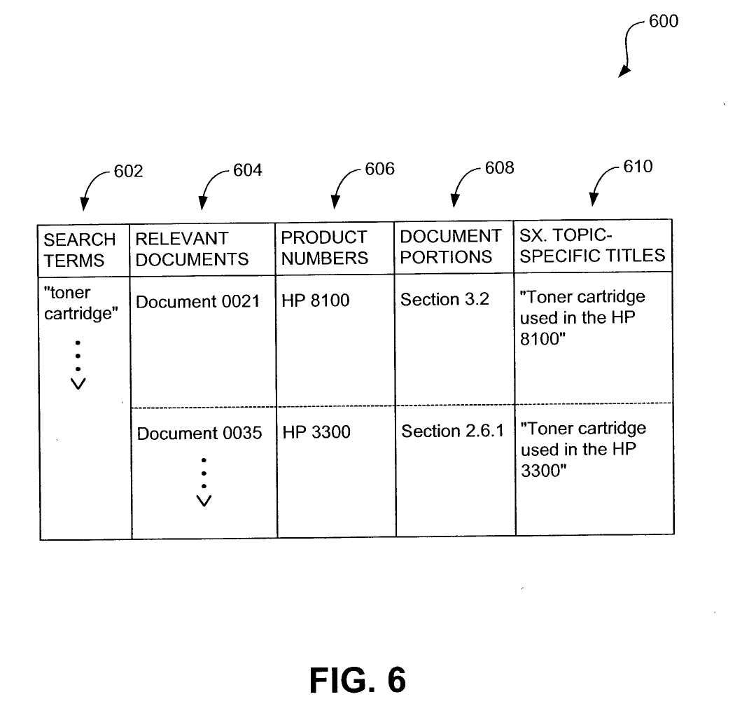

The search engine 318 comprises the various software and/or firmware with which information searches can be facilitated. Such searches can comprise, for instance, the entry of a search query by a user using the user computing device 202, and the provision of search results relevant to the search query. Examples of operation of the search engine 318 are described below with reference to FIGS. 5-6.

The search results can be generated by referencing various different databases including, for example, a documents database 320, a product number database 322, and a search topic-specific database 324. Although these databases are identified as being separate in FIG. 3, one or more of the databases could be combined. Moreover, although the databases are indicated as being located within memory 302 along with the server 316 and the search engine 318, one or more of the databases could reside at another location, for instance within memory of another computing device that is accessible to the computing device 204.

The instructions, or logic or code as these instructions are sometimes called, in the computer programs described herein can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Computer programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, RAM, ROM, an erasable programmable read-only memory (EPROM, EEPROM, or flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

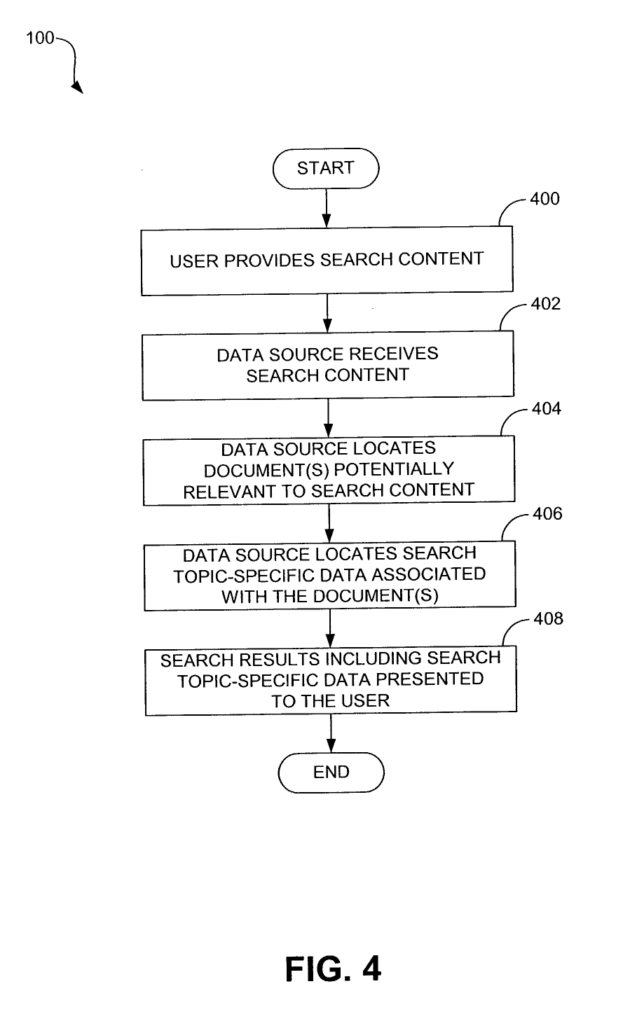

As identified above, the search results presented to customers (i.e., users) by most search engines normally do not include an indication as to which collections of data (e.g., documents) contain the particular information that the user seeks or where that information can be found within the document. FIG. 4 provides an overview of an example method with which such indications can be provided to the user to increase the usefulness of the search results and, more particularly, provide search topic-specific data to the user to aid the user in determining which collections of data contain the desired information.

Beginning with block 400 of FIG. 4, the user first provides search content. By way of example, this search content may comprise a search query that includes one or more words, terms, and/or phrases that relate to the particular information that is sought. After the search content is provided, the data source receives the search content, as indicated in block 402, and then locates one or more documents that are potentially relevant to the search content, as indicated in block 404. Typically, the one or more documents are located by searching a database of documents to determine which of the documents contains words of the search content.

Next, the data source locates, where available, search topic-specific data that are associated with the various located documents, as indicated in block 406. As is described in greater detail below, these data typically comprise information that directly identifies the presence of content that potentially matches the search content and which is contained within the documents. For instance, where a user's search query contained the terms “print speed,” and “8100,” the search topic-specific data may comprise an indication, in the form of a title (i.e., a sentence, or phrase) that indicates the presence of content relevant to the printing speed of a model 8100 printer (e.g., “Print speed for the HP 8100”).

Once the search topic-specific data are located, if available, search results that comprise these data are presented to the user, as indicated in block 408. These results can be arranged as a listing of all located documents, each identified by some form of search topic-specific data. Accordingly, with reference to the previous example, a first entry in the listing may state “Print speed for the HP 8100.” In that the search results include data reflective of the particular search topic entered by the user as opposed to a merely generic, actual document title, the user can more readily determine which of the located documents contains the information that the user seeks.

The general manner in which more meaningful search results can be provided having been described above, a detailed discussion of such provision will now be provided with relation to FIGS. 5A and 5B below. In particular, FIGS. 5A and 5B describe an example of operation of the search engine 318 of a computing device 204 (FIG. 3) in facilitating the provision of search topic-specific data to the user. Beginning with block 500 of FIG. 5A, the search engine 318 receives a search query from a user. This search query may have, for instance, been input by the user on a network (e.g., web) page presented to the user by the network server 316 of the computing device 204. Alternatively, the query may have been input by the user with another form of user interface, for instance an interface of a program that executes on a publicly-available computing device (e.g., in a kiosk of a store, etc.).

Irrespective of the manner in which the search query was input and/or received, the search engine 318 next determines which search words, terms, and/or phrases are contained in the search query, as indicated in block 502. After this determination has been made, the search engine 318 determines whether there are any documents that contain a word, term, and/or phrase provided in the search query, as indicated in decision block 504. To do this, the search engine 318, for example, scans the various documents contained in the documents database 320 so as to conduct a word search of these documents. Depending upon the configuration of the search engine 318, each word may be sought individually, or a group of words (term or phrase) may be sought. Persons having ordinary skill in the art will appreciate the nature of the various search criteria applied in this process.

If no such documents are found, flow proceeds to decision block 528 of FIG. 5B in which, as is discussed below, it can be determined whether to conduct a further (e.g., refined) search. If one or more documents are located, however, flow continues to decision block 506 of FIG. 5A at which it is determined whether there are any product numbers associated with the located documents. By way of example, one or more particular product numbers may be associated with a given document where that the document is specific to one product or line of products (e.g., user's manual, specifications document, etc.). In that users often provide such product numbers in their search queries, it is possible that one or more of these product numbers will also be identified in the user search query. In such circumstances, the product number may narrow the search results for the user. Normally, the product number determination is made by the search engine 318 with reference to the product number database 322.

If there are no product numbers associated with the located documents, flow continues down to decision block 510 described below. If, on the other hand, there are one or more product numbers associated with one or more located documents, flow continues to block 508 at which the product number or numbers is/are recorded by the search engine 318. Such recording may comprise, for instance, storing the product numbers and their associations to the various located documents in volatile or non-volatile memory of the computing device 204. Storage of this information in volatile memory is considered acceptable in that the information need only be stored long enough to generate and display search results to the user.

Next, with reference to decision block 510, the search engine 318 determines whether there are identifiable (i.e., known) portions of the located documents that are particularly relevant to the user's search query. For instance, where the search query pertains to “toner type,” the search engine 318 may determine, as to each located document, which portion of the document particularly relates to the types of toner that can used with the product(s) described in the document. Again, this determination may be made with reference to an appropriate database (see discussion of FIG. 6 below). If there are no such identifiable portions, flow continues to decision block 514 of FIG. 5B. If there are one or more identifiable portions, however, flow continues to block 512 at which an identification of the relevant portion(s) is/are recorded. Again, recordation of this information may be in volatile or non-volatile memory.

Continuing on to decision block 514 of FIG. 5B, the search engine 318 determines whether there are search topic-specific titles available for the located documents. By way of example, these titles may, but need not, directly pertain to the various document portions identified and recorded in blocks 510 and 512. In situations in which this is not the case, the titles at least indicate to the user that a particular document contains the specific information referenced in the titles. The search topic-specific titles can be generated through, for example, heuristic evaluation conducted from a human factors standpoint. Specifically, human factors specialists can, optionally, be used to survey persons of a demographic likely to search a given database to determine what type of information such persons expect or desire to find given the search queries they input. Through such a process, the search topic-specific titles may be more effectively created and associated with the search topics identified in the user's search query. As will be appreciated by persons having ordinary skill in the art, this evaluation can be conducted manually or can be, at least partially, automated through the use of a heuristic evaluation program designed to aid in the creation and association of search topic-specific titles.

The determination as to the availability of search topic-specific titles is typically made by the search engine 318 with reference to the search topic-specific database 324. This database 324 may be accessed by, for instance, referencing a look-up table such as example look-up table 600 shown in FIG. 6. As indicated in this figure, such a look-up table may define associations between search terms 602, located documents 604, product numbers 606, document portions 608, and the topic-specific titles 610.

In the example shown in FIG. 6, the search term “toner cartridge” yields results of at least two documents (document numbers “0021” and “0035”), each of which pertains to a particular product (HP 8100 and HP 3300, respectively) and includes an identifiable portion (sections 3.2 and 2.6.1, respectively) that pertain to toner cartridges. In addition, search topic-specific titles are available for each document and, in this example, for each identified document portion. Although a look-up table is illustrated in FIG. 6 and described herein, it is to be understood that an actual look-up table is not required and that the various information depicted in the table can be associated in other ways such as through the use of tags (e.g., metatags) or other devices that link separate pieces of information together. Accordingly, the look-up table shown in FIG. 6 can be interpreted as merely representative of the various associations between the information identified therein.

Returning to FIG. 5B, if no search topic-specific titles are available, flow continues to block 518 described below. However, if one or more such titles do exist, flow continues to block 516 at which the titles are recorded by the search engine 318. Next, with reference to block 518, the search engine 318 generates the various search results data that are to be displayed to the user. The nature of these data will depend upon which data were located during the previous steps in the process. Preferably, however, these data at least include the product number(s) for products described in the located documents and a search topic-specific title for each located document and/or each identified document portion.

With reference to block 520, search results are then displayed to the user. The nature of these search results will, of course, be dependent upon the data generated in block 518. Typically, however, the search results comprise a listing of documents and/or document portions that are identified by one or more of a product number and a search topic-specific title. As noted above, such information is more indicative of whether a given document contains the desired information than a generic title of the document and/or a cryptic excerpt of the document. In fact, it may be preferable to not reveal the original (i.e., actual) title of the document so as to avoid creating confusion for the user.

Once the search results are displayed to the user, the user can determine whether one or more of the documents appears to contain the information for which the user is searching. Again, assuming search topic-specific titles are provided, this will be a relatively easy determination to make. If the user does identify a relevant document, the user can select the document, for instance by “clicking” on the displayed title with a mouse. It can therefore be determined, at decision block 522, whether the user has selected a document. If not, flow continues to decision block 528 described below. If, on the other hand, a document is selected, flow continues to block 524 at which the document is presented to the user. Such presentation can occur in various different ways. In a preferred arrangement, a portion of the document that was determined by the search engine 318 to be relevant to the search query is directly displayed to the user. In such a case, the entire document may be provided to the user, but the document may be scrolled-down so as to direct the user's attention to the relevant portion of the document. As will be appreciated by persons having ordinary skill in the art, such a feature may save the user a great deal of time that would otherwise have been necessary to locate the desired information within the document, especially in cases in which the document is large.

In an alternative arrangement, only the relevant portions of the located documents are presented to the user for review. In such a case, the search topic-specific titles may directly apply to the various document portions and, as such, specifically identify these portions as opposed to the documents generally.

After the user reviews the selected document, the user can then determine whether to review a further document, for instance if he or she did not see the information that is sought. Accordingly, it can be determined whether another document has been selected, as indicated in decision element 526. If so, flow returns to block 524 described above. If not, however, flow continues to decision block 528 at which it is determined whether a new search is to be conducted (i.e. at the request of the user). If not, the user presumably located the desired information and flow for the search session is terminated. If another search is desired, however, flow returns back to block 500 of FIG. 5A, and the above-described process is repeated for a new search query.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for facilitating information searches, comprising:
receiving search content;
locating a document that is potentially relevant to the search content; and
providing search results that identify the located document, the search results including a search topic-specific title that is other than an actual title of the document.

2. The method of claim 1, wherein the step of receiving search content comprises receiving a search query that includes at least one of a word, a term, and a phrase.

3. The method of claim 2, wherein the step of locating a document comprises conducting a word search of a database of documents to locate the at least one of a word, a term, and a phrase.

4. The method of claim 1, wherein the step of providing search results comprises providing a search topic-specific title that is pertinent to an identifiable portion of the document.

5. The method of claim 1, wherein the step of providing search results comprises providing a search topic-specific title that is generated as a result of heuristic evaluation.

6. The method of claim 1, further comprising providing the document to a user for review.

7. The method of claim 6, wherein the step of providing the document comprises directly presenting a portion of the document to the user that is pertinent to the search content.

8. The method of claim 1, further comprising providing a product number in the search results that is relevant to the located document.

9. A system for facilitating information searches, comprising:
means for receiving search content input by a user;
means for locating document that is potentially relevant to the input search content;
means for locating a search topic-specific title that is other than an actual title of the document; and
means for providing search results that identify the located document, the search results including the search topic-specific title.

10. The system of claim 9, wherein the search topic-specific data comprise a search topic-specific title other than an actual title of the document.

11. The system of claim 10, wherein the search topic-specific title is pertinent to a particular identifiable portion of the document.

12. The system of claim 9, further comprising means for providing the document to the user such that a portion of the document that is pertinent to the search content is directly presented to the user.

13. The system of claim 9, further comprising means for providing a product number in the search results that is relevant to the located document.

14. A method for providing search results specifically indicative of content desired by a user, comprising:
receiving a search query input by the user;
determining at least one of a search word, term, and phrase of the search query;
conducting a word search of a documents database to locate at least one document that is potentially relevant to a search topic of the search query;
locating at least one search topic-specific title that is associated with the at least one located document, the search topic-specific title identifying that the document contains content that is pertinent to the search topic; and
presenting search results to the user that identify the at least one located document with the at least one search topic-specific title.

15. The method of claim 14, wherein the step of locating at least one search topic-specific title comprises locating at least one search topic-specific title generated as a result of heuristic evaluation.

16. The method of claim 14, further comprising providing the at least one located document to the user for review.

17. The method of claim 16, wherein the step of providing the document comprises presenting the document such that it is scrolled-down to a portion of the document that is pertinent to the search topic to pinpoint the location of the pertinent document portion for the user.

18. The method of claim 14, further comprising providing a product number in the search results that is relevant to the at least one located document.

19. A search engine stored on a computer-readable medium, comprising:
logic configured to locate a document that is potentially relevant to a search query input by a user;
logic configured to locate a search topic-specific title that specifically identifies content contained within the located document that is pertinent to a search topic of the search query; and
logic configured to generate search results data that identify the located document with the search topic-specific title.

20. The search engine of claim 19, further comprising logic configured to provide the document to the user such that a portion of the document that is pertinent to the search content is directly presented to the user.

21. The search engine of claim 19, further comprising logic configured to provide a product number in the search results that is relevant to the located document.

22. The search engine of claim 19, further comprising at least one of a documents database, a product number database, and a search topic-specific database.
